(19) United States
(12) Patent Application Publication
(10) Pub. No.: US 2018/0130101 A1
(43) Pub. Date: May 10, 2018

(54) ONLINE METHOD AND SYSTEM FOR VALUE ESTIMATIONS

(71) Applicant: Anania Albert KHAMU, Chambers Flat QLD (AU)

(72) Inventor: Anania Albert KHAMU, Chambers Flat QLD (AU)

(21) Appl. No.: 15/864,160

(22) Filed: Jan. 8, 2018

Related U.S. Application Data
(63) Continuation of application No. PCT/AU2016/050592, filed on Jul. 7, 2016.

(30) Foreign Application Priority Data
Jul. 8, 2015 (AU) 2015902698

(51) Int. Cl. G06Q 30/02; G06Q 50/16

(52) U.S. Cl. CPC G06Q 30/0278; G06Q 50/163

(57) ABSTRACT

Disclosed herein are a method and system for determining an overall value rating or value estimate in relation to a product that is to be offered for sale or lease. The method includes the steps of identifying a product type associated with the product and determining a set of attributes for the identified product type. The method calculates a value score unit size for the product, based on statistical data relating to the product and the product type, determines an attribute value multiplier associated with each attribute in the set of attributes and presents an attribute template (130) to a seller associated with the product that is to be offered for sale or lease, the attribute template including the set of attributes. The method receives data from the seller in relating to each attribute in the set of attributes (140). For each attribute in the attribute template, the method determines an attribute rating value based on the received data and the attribute value multiplier associated with that attribute (150) and then determines the overall rating value (160), based on a sum of the attribute rating values and an asking price submitted by the seller.

### RELATED APPLICATIONS

The present application is related to Australian Provisional Patent Application No. 2015902698 filed 8 Jul. 2015 and International Patent Application No. PCT/AU2016/050592 titled “Online method and system for value estimations” and filed 7 Jul. 2016 in the name of Anania Albert Khamu, the entire content of each of which is incorporated by reference as if fully set forth herein.

### TECHNICAL FIELD

The present disclosure relates to a marketplace for selling products in an online environment and, in particular, to an online method and system with a value calculator for determining a value rating or value estimate.

### BACKGROUND

A marketplace provides an environment for buyers and sellers to trade goods and services, often in exchange for money or other goods and services. Marketplaces take many forms, from physical trading locations to stock markets. More recently, the online environment provided by networked computers has spawned online auction and trading websites, such as eBay, Craigslist, gumtree, and the like. Further, many businesses operate associated websites that allow consumers to purchase goods and services.

It is often said that the market determines the price or value of a given item. In this sense, the market refers to the behaviours of buyers and sellers, with recent sales acting as a reflection of the current demand for any particular product.

A buyer contemplating the purchase of a large volume consumer item is able to search online websites for prices and reviews to determine, without undue effort, whether an offer from a particular retailer, either online or otherwise, represents good value for money based on the specification and features of the item and the asking price. However, not all items are as easy to compare and consequently it is often difficult for the buyer to determine whether or not an offer represents good value for money.

For example, it is relatively easy to determine whether an offer in relation to a new car represents good value. However, determining an offer in relation to a used car is much more difficult. Various industry publications, such as the Glass's Guide, Kelley Blue Book, or RedBook, provide valuations for particular car models based on age and average conditions. While these publications provide a starting point, they do not account for modifications made to a particular car, different garaging or storage conditions, actual mileage of the vehicle, and the like. While two cars may start out the same and be sold at the same time, the same cars when offered for sale a number of years later may have very different values.

A product that is often difficult to assess in terms of value for money is real estate, as no two properties are identical. Even two units within the same new building have differences in relation to aspect and proximity to lifts, which can affect the value of those otherwise identical properties. As time passes, the condition of the two units will diverge, depending on maintenance, updates, renovations, and the like. Further, different houses have many different attributes, which makes it even harder to determine what represents good value for money. Such attributes include, for example, different size and shape blocks of land, different fittings and fixtures, different aspects, zoning of neighbouring properties, and proximity to transport, schools, and shops.

Thus, a need exists to provide an improved online marketplace that provides a user with an indication of whether an offer for sale in relation to a product represents good value for money.

### SUMMARY

The present disclosure relates to an online marketplace in which each product offered for sale is associated with a value rating. The value rating is based on cumulative attribute ratings of one or more attributes associated with the product.

In a first aspect, the present disclosure provides a method for determining an overall value rating in relation to a product that is to be offered for sale or lease, comprising the steps of:

identifying a product type associated with the product;

determining a set of attributes for the identified product type;

determining an attribute value multiplier associated with each attribute in said set of attributes;

determining a weighted score for each of said attributes, based on a statistical value associated with the attribute and the corresponding attribute value multiplier;

calculating a value score unit size for the product, based on statistical data relating to the product and the product type and a sum of said weighted scores;

presenting an attribute template to a user, said attribute template including said set of attributes;

receiving data from said user in relation to each attribute in said set of attributes;

for each attribute in said attribute template, determining an attribute rating value based on said received data and the attribute value multiplier associated with that attribute; and

determining the overall rating value, based on an asking price submitted by a seller of said product and a product of a sum of the attribute rating values and said value score unit size.

In one arrangement, the user is one of a prospective purchaser of the product or the seller of the product.

In a second aspect, the present disclosure provides a system for determining an overall value rating in relation to a product that is to be offered for sale or lease, said system comprising:

a server, said server including:
a memory for storing data and a computer program;
a processor coupled to said memory for executing said computer program stored in said memory;

a ratings application forming part of said computer program, said ratings application including instructions for performing the method steps of:
identifying a product type associated with the product;
determining a set of attributes for the identified product type;
determining an attribute value multiplier associated with each attribute in said set of attributes;
determining a weighted score for each of said attributes, based on a statistical value associated with the attribute and the corresponding attribute value multiplier;
calculating a value score unit size for the product, based on statistical data relating to the product and the product type and a sum of said weighted scores;
presenting an attribute template to a user, said attribute template including said set of attributes;
receiving data from said user in relation to each attribute in said set of attributes;
for each attribute in said attribute template, determining an attribute rating value based on said received data and the attribute value multiplier associated with that attribute;

determining the overall rating value, based on an asking price submitted by a seller of said product and a product of a sum of the attribute rating values and said value score unit size.

In a third aspect, the present disclosure provides a computer readable storage medium having recorded thereon a computer program for determining an overall value rating in relation to a product that is to be offered for sale or lease, said computer program comprising code for performing the steps of:

identifying a product type associated with the product;

determining a set of attributes for the identified product type;

determining an attribute value multiplier associated with each attribute in said set of attributes;

determining a weighted score for each of said attributes, based on a statistical value associated with the attribute and the corresponding attribute value multiplier;

calculating a value score unit size for the product, based on statistical data relating to the product and the product type and a sum of said weighted scores;

presenting an attribute template to a user, said attribute template including said set of attributes;

receiving data from said user in relation to each attribute in said set of attributes;

for each attribute in said attribute template, determining an attribute rating value based on said received data and the attribute value multiplier associated with that attribute;

determining the overall rating value, based on an asking price submitted by a seller of said product and a product of a sum of the attribute rating values and said value score unit size.

In a fourth aspect, the present disclosure provides a method for determining a value estimate in relation to a product, comprising the steps of:

identifying a product type associated with the product;

determining a set of attributes for the identified product type;

determining an attribute value multiplier associated with each attribute in said set of attributes;

determining a weighted score for each of said attributes, based on a statistical value associated with the attribute and the corresponding attribute value multiplier;

calculating a value score unit size for the product, based on statistical data relating to the product and the product type and a sum of said weighted scores;

presenting an attribute template to a user, said attribute template including said set of attributes;

receiving data from said user in relation to at least one attribute in said set of attributes;

for each attribute in said attribute template, determining an attribute rating value based on said received data and the attribute value multiplier associated with that attribute; and

determining an overall value estimate, based on a product of said value score unit size and a sum of the attribute rating values.

In a fifth aspect, the present disclosure provides a system for determining a value estimate in relation to a product, said system comprising:

a server, said server including:
a memory for storing data and a computer program;
a processor coupled to said memory for executing said computer program stored in said memory;

a ratings application forming part of said computer program, said ratings application including instructions that when executed on said processor perform the method steps of:
identifying a product type associated with the product;
determining a set of attributes for the identified product type;
determining an attribute value multiplier associated with each attribute in said set of attributes;
determining a weighted score for each of said attributes, based on a statistical value associated with the attribute and the corresponding attribute value multiplier;
calculating a value score unit size for the product, based on statistical data relating to the product and the product type and a sum of said weighted scores;
presenting an attribute template to a user, said attribute template including said set of attributes;
receiving data from said user relating to each attribute in said set of attributes;
for each attribute in said attribute template, determining an attribute rating value based on said received data and the attribute value multiplier associated with that attribute;
determining an overall value estimate, based on a product of said value score unit and a sum of the attribute rating values.

According to another aspect, the present disclosure provides an apparatus for implementing any one of the aforementioned methods.

According to another aspect, the present disclosure provides a computer program product including a computer readable medium having recorded thereon a computer program for implementing any one of the methods described above.

Other aspects of the present disclosure are also provided.

### BRIEF DESCRIPTION OF THE DRAWINGS

One or more embodiments of the present disclosure will now be described by way of specific example(s) with reference to the accompanying drawings, in which:

FIG. 1 is a flow diagram illustrating a method of generating a value rating for a product to be offered for sale;

FIG. 2 is a schematic representation of a system on which one or more embodiments of the present disclosure may be practised;

FIG. 3 are schematic block diagram representations of a system that includes a general purpose computer on which one or more embodiments of the present disclosure may be practised;

FIG. 4 is a schematic block diagram representation of a system that includes a general smartphone on which one or more embodiments of the present disclosure may be practised;

FIGS. 5A to 5X are schematic representations illustrating a user populating an attribute template for a product to be offered for sale; and

FIGS. 6A to 6D are schematic representations of screenshots of a computing device executing a software application embodying a method for generating a value for a product offered for sale.

### DETAILED DESCRIPTION

Method steps or features in the accompanying drawings that have the same reference numerals are to be considered to have the same function(s) or operation(s), unless the contrary intention is expressed or implied.

The present disclosure provides an online marketplace in which each product offered for sale is associated with a value rating. The value rating is based on cumulative attribute ratings of one or more attributes associated with the product. A hosted website is accessible by both buyers and sellers. The website defines a set of attributes for each product type that can be offered for sale in an online marketplace component of the website. A seller wanting to offer a product for sale completes an attribute template for the product, wherein the attribute template matches the product type of the product for sale. While the specification refers to products for sale, it will be appreciated that the invention may equally be practised on products for lease or hire.

The set of attributes reflects the properties of the respective product types. For example, product types may include, but are not limited to, real estate, cars, and boats. Depending on the implementation, product types may be further broken down, such that the broad product type of real estate may include houses, units, town houses, villas, and commercial properties.

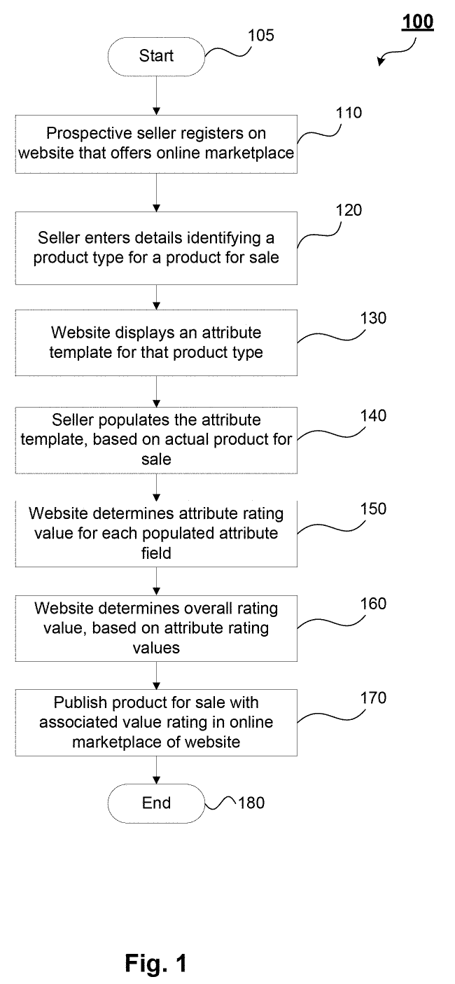

FIG. 1 is a flow diagram illustrating a method 100 for determining a value rating of a product for sale, in accordance with the present disclosure. The method 100 begins at a Start step 105 and proceeds to step 110, in which a prospective seller uses a computing device to access and register with a website that offers an online marketplace. The website includes a registration module, which issues a username and password to the prospective seller on receipt of personal information, such as name and contact details. The online marketplace caters to a set of product types. For each product type, the website stores a predefined set of attributes.

Control passes to step 120, in which the prospective seller enters a product type corresponding to a product that is to be offered for sale. The product type may be, for example, a house, unit/apartment, townhouse, villa, car, truck, or boat.

Control passes from step 120 to step 130, in which the website presents an attribute template for display on the computing device being accessed by the prospective seller. The attribute template is based on the predefined set of attributes associated with the product type input by the prospective seller in step 120. The attribute template includes a set of attribute names and corresponding attribute fields to be completed by the prospective seller. In step 140, the prospective seller completes the attribute fields by entering information about the product for sale or selecting answers from a list of options offered for each attribute name.

For each attribute name in the attribute template, a ratings calculator associated with a server hosting the website determines a value multiplier. The value multiplier is representative of the value that the presence or absence of each attribute has to the ultimate value of the product that is to be offered for sale. For example, the presence of a study adds more value to the overall value of a house than the presence of a spa bath. In one arrangement, the value multiplier for each attribute is dependent on a percentage of the average sale price of comparable products or other statistical information relating to the same or similar products. For example, when the product to be offered for sale is a house, the value multiplier is dependent on a percentage of the average house price in the same local area as the house that is to be offered for sale.

Control passes to step 150, which calculates an attribute rating value for each attribute field, based on the information or answers provided by the prospective seller. In an alternative arrangement, the website calculates an attribute rating value for each attribute field as that field is populated.

Control passes from step 150 to step 160, which determines an overall value rating, based on the sum of the attribute rating values. In one arrangement, the overall value rating is the sum of the attribute rating values. In another arrangement, the overall value rating is the difference between an asking price nominated by the prospective seller in relation to the product for sale and the sum of the attribute rating values.

In step 170, the website publishes the product for sale as a listing in the online marketplace of the website, wherein the listing includes the value rating determined in step 160. Prospective buyers are thus able to readily see whether the product offered for sale represents value for money in a general sense and can compare the product with other products offered for sale through the marketplace based on their respective value ratings. Control passes from step 170 to step 180 and the method 100 terminates.

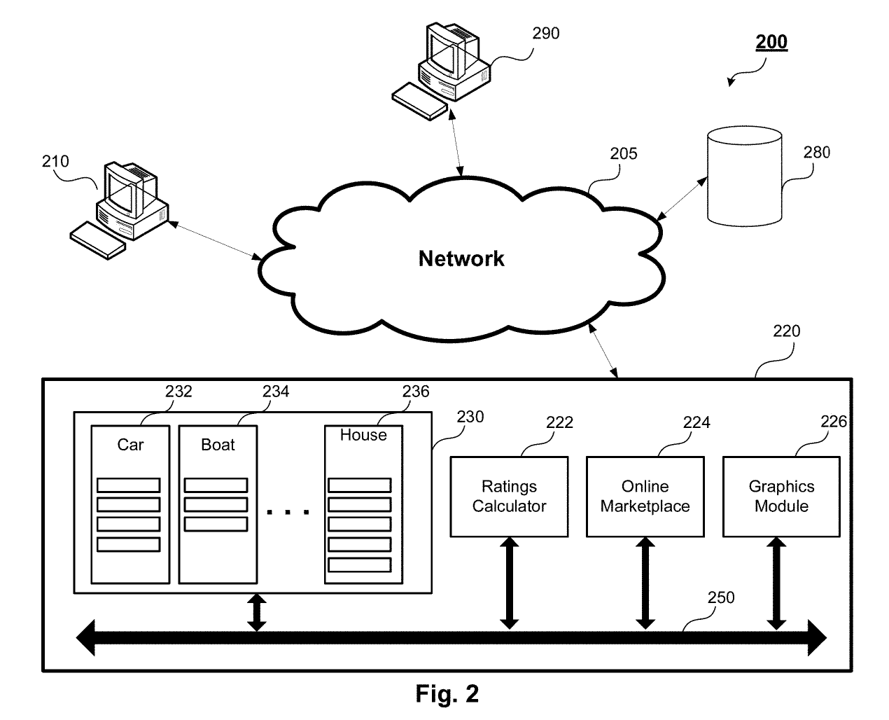

FIG. 2 is a schematic representation of a system 200 on which one or more embodiments of the present disclosure may be practised. The system 200 includes a computer server 220 coupled to a communications network 205, such as the Internet. The server 220 hosts a website that can be accessed by users via the network 205. The server 220 includes an online marketplace module 224 that provides a portion of the website in which buyers can view and purchase products offered for sale by sellers registered with the website. The server 220 also includes a graphics module 226, which stores one or more graphical images, shapes, template layouts, and the like for display on the website to a visiting user.

The server 220 also includes a ratings calculator 222, which determines an overall value rating for each product that is to be listed for sale in the online marketplace. The server 220 further includes a product type database 230, which includes a set of product types 232, 234, 236. Each product type 232, 234, 236 has an associated set of attributes. As can be seen from FIG. 2, different product types may be associated with a different number of attributes. The graphics module 226, the online marketplace 224, the ratings calculator 222 and the product type database 230 exchange information using one or more busses 250.

In one arrangement, the product types 232, 234, 236 correspond to different product types that may be offered for sale on the online marketplace 224. In one example, product type 1 232 refers to cars, product type 2 234 refers to boats, and product type 236 refers to houses. In this example, a car has the attributes make, model, age, and mileage. Further, a boat has the attributes length, draft, and beam. A house has many attributes, including address, property size, number of bedrooms, number of bathrooms, car spaces, and the like.

The system 200 also includes a statistics database 290. The statistics database 290 may be integral with the server 220 or external to the server 220, as shown in FIG. 2. The statistics module 290 is coupled to the server 220, in this example via the communications network 205, to provide information relating to various product types. In the example of the product type “house”, the statistics module 290 provides information relevant to that product type, such as the median house price for houses based on a geographical location.

The system 200 also includes a first computing device 210 accessed by a prospective seller. The seller uses the first computing device 210 to communicate with the website hosted by the server 220, via the communications network 205. As described with reference to FIG. 1, the seller registers with the website and then selects a valid product type from the set of product types in the product type database 230. In this example, the user selects “house” as the product type.

The server 220 uses a template from the graphics module 226 to display information to a display screen of the first computing device 210. The template is specific to the product type selected by the seller and includes the set of attributes associated with the selected product type. In one arrangement, each attribute has a corresponding check box, whereby the seller indicates in a quick and convenient manner whether or not the product for sale has that attribute.

The ratings calculator provides an attribute rating value for each attribute. The rating value for an attribute depends on the overall contribution of that attribute to the selling price of the product. For example, the number of bedrooms in a house for sale has more influence on the selling price than whether the kitchen benchtops are stone or laminate, and so the attribute rating value awarded to the number of bedrooms attribute is greater than the kitchen benchtop attribute.

The ratings calculator normalises the attribute rating values.

Once the seller has completed the template, the ratings calculator 222 compares the sum of the individual attribute rating values with a nominated selling price provided by the seller to determine an overall rating value. If the overall rating value is a positive value, this indicates that the product for sale represents good value for a prospective buyer. If the overall rating value is a negative value, this indicates that the product for sale does not represent good value for a prospective buyer.

The product is then available to be listed on the online marketplace 224, at which point the product will be able to be viewed, with the associated overall rating value, by prospective buyers. For example, a prospective buyer uses a second computing device 290 coupled to the communications network 205 to view the online marketplace 224 of the website hosted on the server 220. Depending on the implementation, products for sale on the online marketplace 224 can be sorted based on the associated overall rating values. In one implementation, only products for sale with a positive overall rating value are listed on the online marketplace 224. The prospective buyer is then able to purchase the product for sale through a payment gateway associated with the online marketplace 224 or other means as well known in the art.

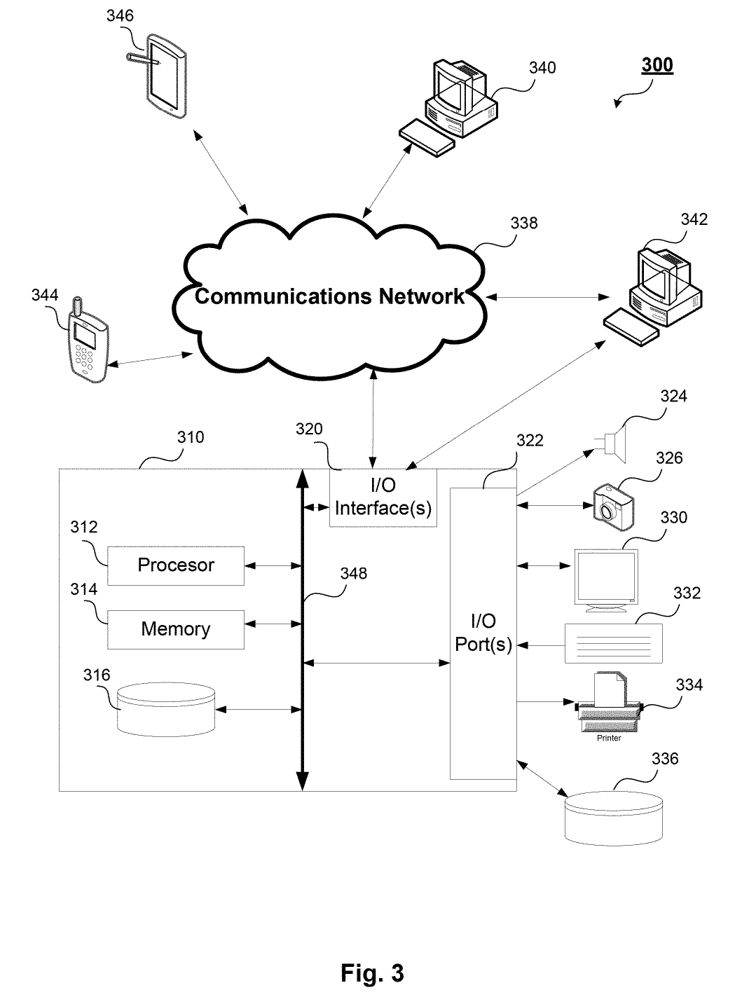

The first and second computing devices 210, 290 and the server 220 of the online marketplace system of the present disclosure may be practised using a computing device, such as a general purpose computer or computer server. FIG. 3 is a schematic block diagram of a system 300 that includes a general purpose computer 310. The general purpose computer 310 includes a plurality of components, including: a processor 312, a memory 314, a storage medium 316, input/output (I/O) interfaces 320, and input/output (I/O) ports 322. Components of the general purpose computer 310 generally communicate using one or more buses 348.

The memory 314 may be implemented using Random Access Memory (RAM), Read Only Memory (ROM), or a combination thereof. The storage medium 316 may be implemented as one or more of a hard disk drive, a solid state “flash” drive, an optical disk drive, or other storage means. The storage medium 316 may be utilised to store one or more computer programs, including an operating system, software applications, and data. In one mode of operation, instructions from one or more computer programs stored in the storage medium 316 are loaded into the memory 314 via the bus 348. Instructions loaded into the memory 314 are then made available via the bus 348 or other means for execution by the processor 312 to implement a mode of operation in accordance with the executed instructions.

One or more peripheral devices may be coupled to the general purpose computer 310 via the I/O ports 322. In the example of FIG. 3, the general purpose computer 310 is coupled to each of a speaker 324, a camera 326, a display device 330, an input device 332, a printer 334, and an external storage medium 336. The speaker 324 may be implemented using one or more speakers, such as in a stereo or surround sound system.

The camera 326 may be a webcam, or other still or video digital camera, and may download and upload information to and from the general purpose computer 310 via the I/O ports 322, dependent upon the particular implementation. For example, images recorded by the camera 326 may be uploaded to the storage medium 316 of the general purpose computer 310. Similarly, images stored on the storage medium 316 may be downloaded to a memory or storage medium of the camera 326. The camera 326 may include a lens system, a sensor unit, and a recording medium.

The display device 330 may be a computer monitor, such as a cathode ray tube screen, plasma screen, or liquid crystal display (LCD) screen. The display 330 may receive information from the computer 310 in a conventional manner, wherein the information is presented on the display device 330 for viewing by a user. The display device 330 may optionally be implemented using a touch screen to enable a user to provide input to the general purpose computer 310. The touch screen may be, for example, a capacitive touch screen, a resistive touchscreen, a surface acoustic wave touchscreen, or the like.

The input device 332 may be a keyboard, a mouse, a stylus, drawing tablet, or any combination thereof, for receiving input from a user. The external storage medium 336 may include an external hard disk drive (HDD), an optical drive, a floppy disk drive, a flash drive, or any combination thereof and may be implemented as a single instance or multiple instances of any one or more of those devices. For example, the external storage medium 336 may be implemented as an array of hard disk drives.

The I/O interfaces 320 facilitate the exchange of information between the general purpose computing device 310 and other computing devices. The I/O interfaces may be implemented using an internal or external modem, an Ethernet connection, or the like, to enable coupling to a transmission medium. In the example of FIG. 3, the I/O interfaces 322 are coupled to a communications network 338 and directly to a computing device 342. The computing device 342 is shown as a personal computer, but may be equally be practised using a smartphone, laptop, or a tablet device. Direct communication between the general purpose computer 310 and the computing device 342 may be implemented using a wireless or wired transmission link.

The communications network 338 may be implemented using one or more wired or wireless transmission links and may include, for example, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a mobile telephone cellular network, a short message service (SMS) network, or any combination thereof. The general purpose computer 310 is able to communicate via the communications network 338 to other computing devices connected to the communications network 338, such as the mobile telephone handset 344, the touchscreen smartphone 346, the personal computer 340, and the computing device 342.

One or more instances of the general purpose computer 310 may be utilised to implement a server acting as a host of a website to implement an online marketplace with associated ratings calculator in accordance with the present disclosure. In such an embodiment, the memory 314 and storage 316 are utilised to store data relating to product types and associated sets of attributes, templates, graphics, and other information relating to products listed for sale or to be listed for sale. Software for implementing the online marketplace system is stored in one or both of the memory 314 and storage 316 for execution on the processor 312. The software includes computer program code for implementing method steps in accordance with the method of determining an overall rating value for a product to be sold as described herein.

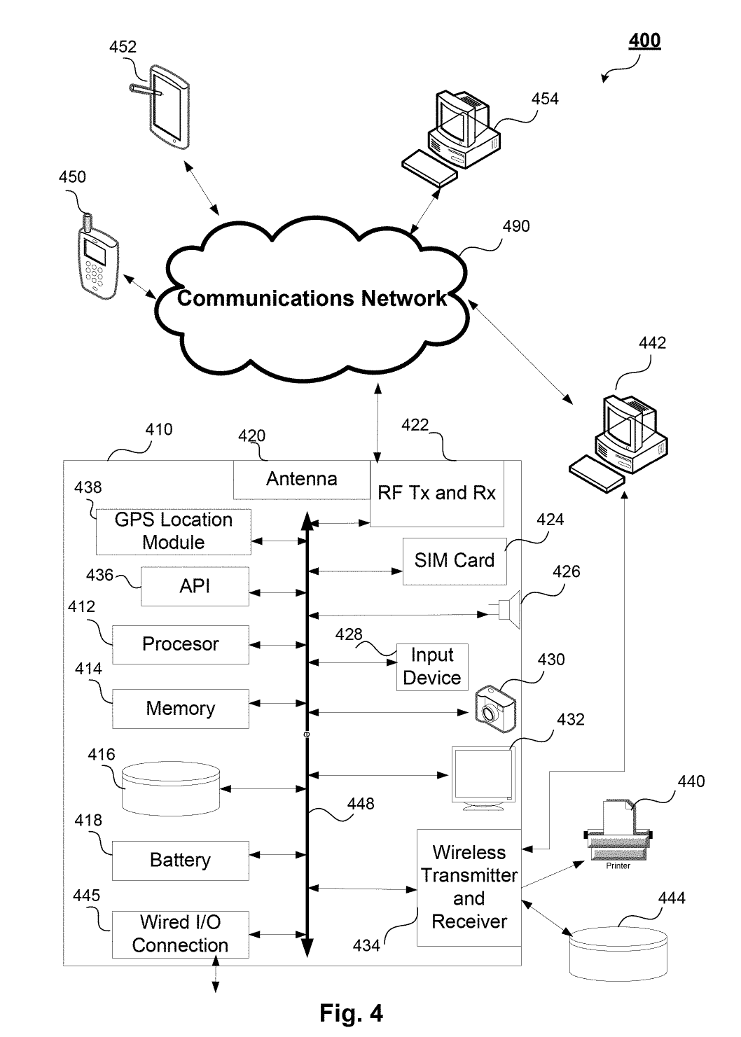

FIG. 4 is a schematic block diagram of a system 400 on which one or more aspects of an online marketplace method and system of the present disclosure may be practised. The system 400 includes a portable computing device in the form of a smartphone 410, which may be used by a registered user or prospective buyer of the online marketplace system in FIG. 2. The smartphone 410 includes a plurality of components, including: a processor 412, a memory 414, a storage medium 416, a battery 418, an antenna 420, a radio frequency (RF) transmitter and receiver 422, a subscriber identity module (SIM) card 424, a speaker 426, an input device 428, a camera 430, a display 432, and a wireless transmitter and receiver 434. Components of the smartphone 410 generally communicate using one or more bus connections 448 or other connections therebetween. The smartphone 410 also includes a wired connection 445 for coupling to a power outlet to recharge the battery 418 or for connection to a computing device, such as the general purpose computer 310 of FIG. 3. The wired connection 445 may include one or more connectors and may be adapted to enable uploading and downloading of content from and to the memory 414 and SIM card 424.

The smartphone 410 may include many other functional components, such as an audio digital-to-analogue and analogue-to-digital converter and an amplifier, but those components are omitted for the purpose of clarity. However, such components would be readily known and understood by a person skilled in the relevant art.

The memory 414 may include Random Access Memory (RAM), Read Only Memory (ROM), or a combination thereof. The storage medium 416 may be implemented as one or more of a solid state “flash” drive, a removable storage medium, such as a Secure Digital (SD) or microSD card, or other storage means. The storage medium 416 may be utilised to store one or more computer programs, including an operating system, software applications, and data. In one mode of operation, instructions from one or more computer programs stored in the storage medium 416 are loaded into the memory 414 via the bus 448. Instructions loaded into the memory 414 are then made available via the bus 448 or other means for execution by the processor 412 to implement a mode of operation in accordance with the executed instructions.

The smartphone 410 also includes an application programming interface (API) module 436, which enables programmers to write software applications to execute on the processor 412. Such applications include a plurality of instructions that may be pre-installed in the memory 414 or downloaded to the memory 414 from an external source, via the RF transmitter and receiver 422 operating in association with the antenna 420 or via the wired connection 445.

The smartphone 410 further includes a Global Positioning System (GPS) location module 438. The GPS location module 438 is used to determine a geographical position of the smartphone 410, based on GPS satellites, cellular telephone tower triangulation, or a combination thereof. The determined geographical position may then be made available to one or more programs or applications running on the processor 412.

The wireless transmitter and receiver 434 may be utilised to communicate wirelessly with external peripheral devices via Bluetooth, infrared, or other wireless protocol. In the example of FIG. 4, the smartphone 410 is coupled to each of a printer 440, an external storage medium 444, and a computing device 442. The computing device 442 may be implemented, for example, using the general purpose computer 310 of FIG. 3.

The camera 426 may include one or more still or video digital cameras adapted to capture and record to the memory 414 or the SIM card 424 still images or video images, or a combination thereof. The camera 426 may include a lens system, a sensor unit, and a recording medium. A user of the smartphone 410 may upload the recorded images to another computer device or peripheral device using the wireless transmitter and receiver 434, the RF transmitter and receiver 422, or the wired connection 445.

In one example, the display device 432 is implemented using a liquid crystal display (LCD) screen. The display 432 is used to display content to a user of the smartphone 410. The display 432 may optionally be implemented using a touch screen, such as a capacitive touch screen or resistive touchscreen, to enable a user to provide input to the smartphone 410.

The input device 428 may be a keyboard, a stylus, or microphone, for example, for receiving input from a user. In the case in which the input device 428 is a keyboard, the keyboard may be implemented as an arrangement of physical keys located on the smartphone 610. Alternatively, the keyboard may be a virtual keyboard displayed on the display device 432.

The SIM card 424 is utilised to store an International Mobile Subscriber Identity (IMSI) and a related key used to identify and authenticate the user on a cellular network to which the user has subscribed. The SIM card 424 is generally a removable card that can be used interchangeably on different smartphone or cellular telephone devices. The SIM card 424 can be used to store contacts associated with the user, including names and telephone numbers. The SIM card 424 can also provide storage for pictures and videos. Alternatively, contacts can be stored on the memory 414.

The RF transmitter and receiver 422, in association with the antenna 420, enable the exchange of information between the smartphone 410 and other computing devices via a communications network 490. In the example of FIG. 4, RF transmitter and receiver 422 enable the smartphone 410 to communicate via the communications network 490 with a cellular telephone handset 450, a smartphone or tablet device 452, a computing device 454 and the computing device 442. The computing devices 454 and 442 are shown as personal computers, but each may be equally be practised using a smartphone, laptop, or a tablet device.

The communications network 490 may be implemented using one or more wired or wireless transmission links and may include, for example, a cellular telephony network, a dedicated communications link, a local area network (LAN), a wide area network (WAN), the Internet, a telecommunications network, or any combination thereof. A telecommunications network may include, but is not limited to, a telephony network, such as a Public Switch Telephony Network (PSTN), a cellular (mobile) telephone cellular network, a short message service (SMS) network, or any combination thereof.

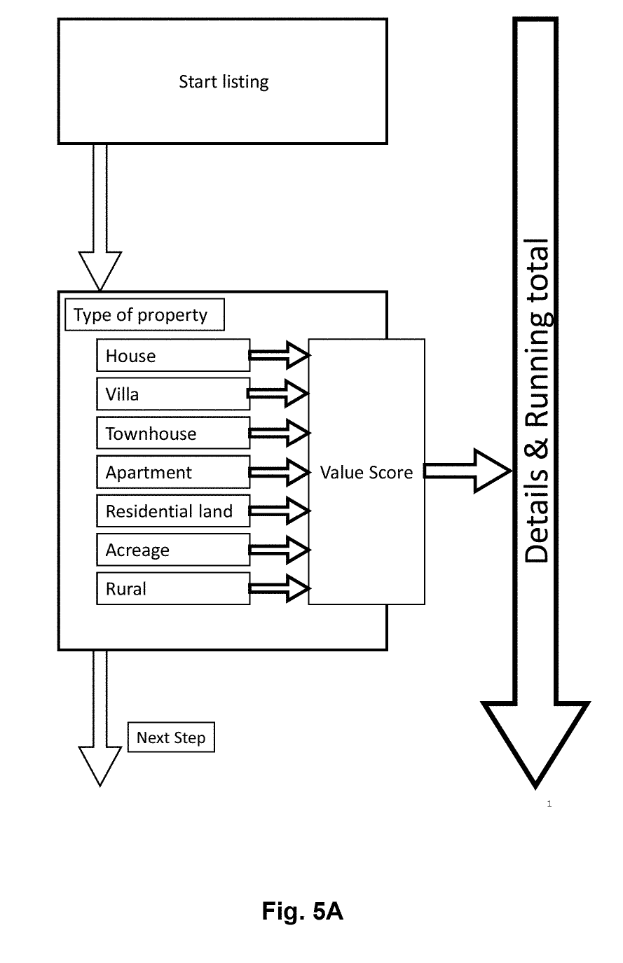

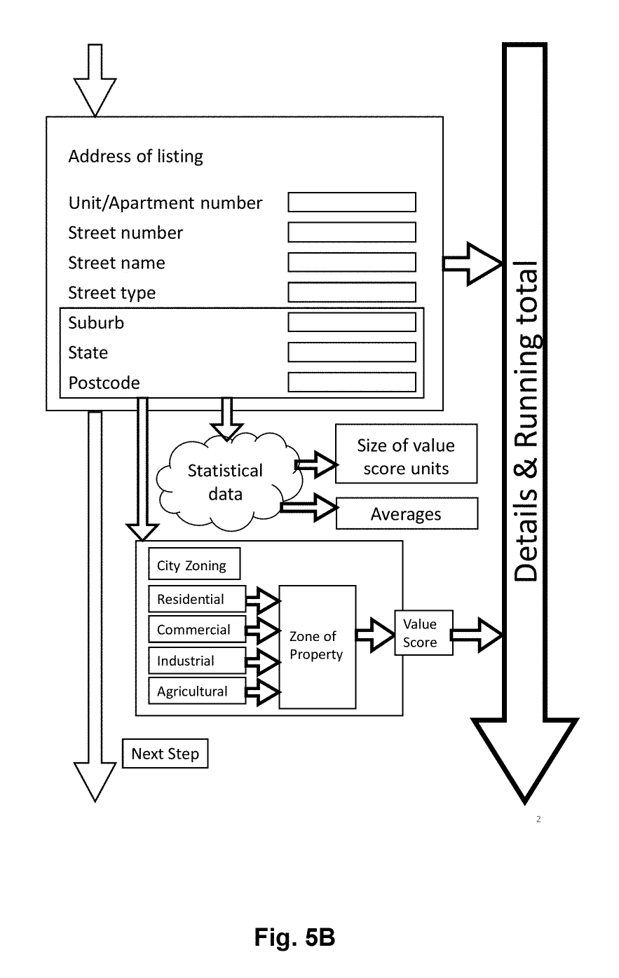

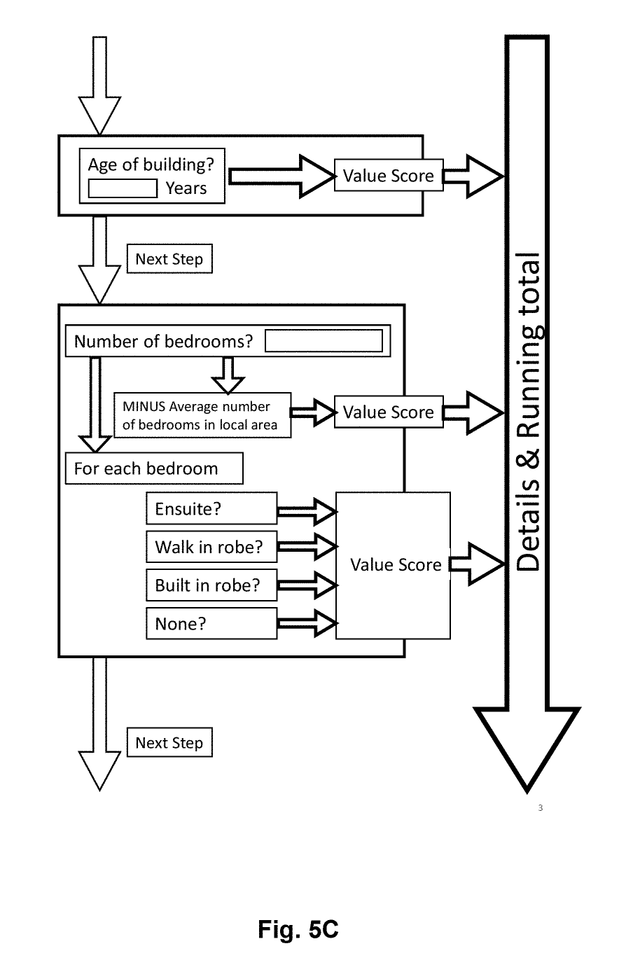

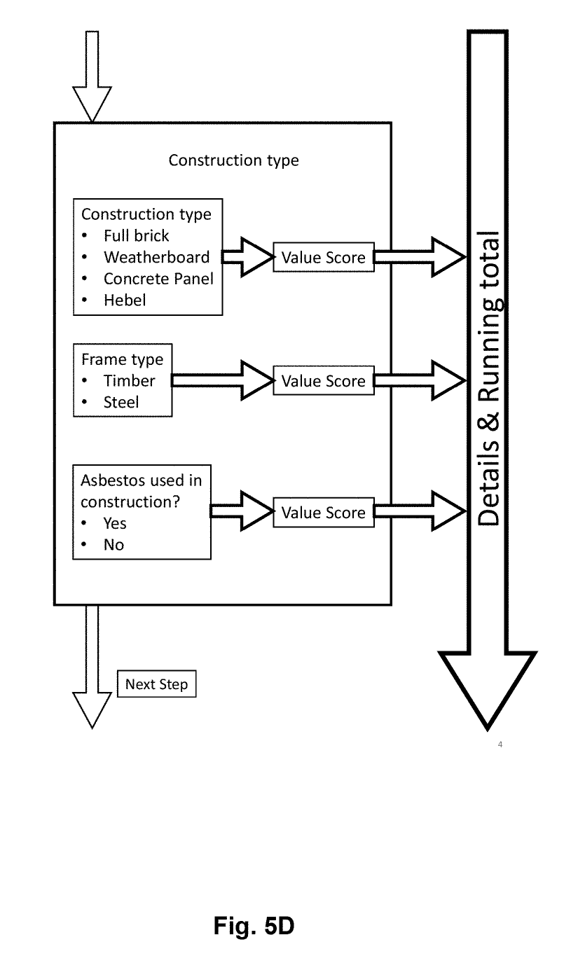

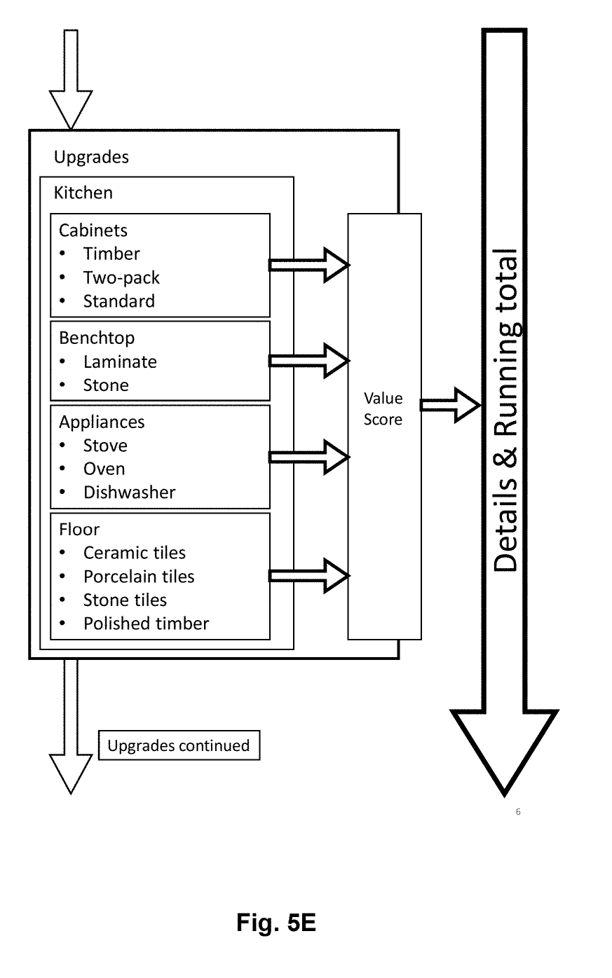

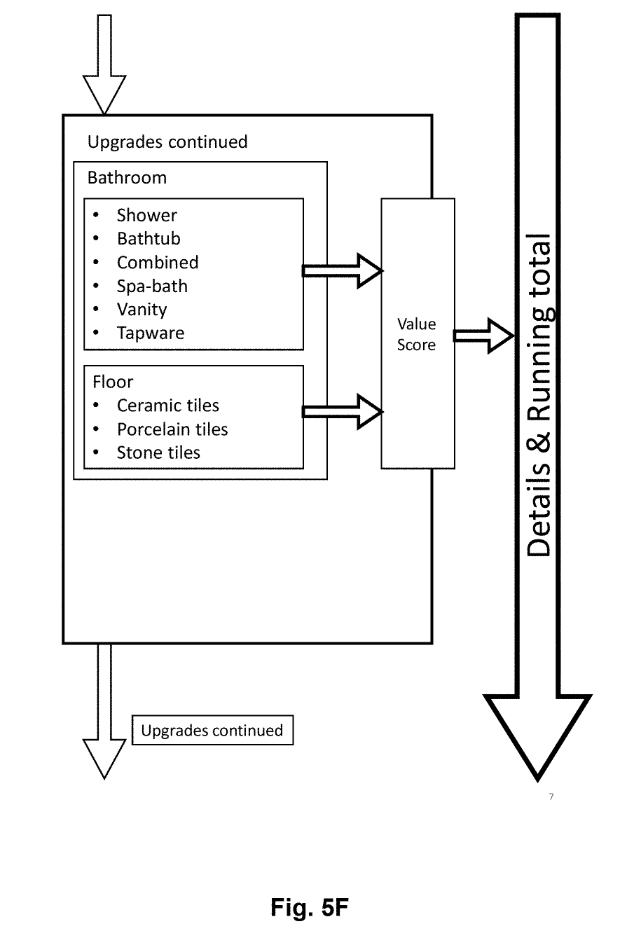

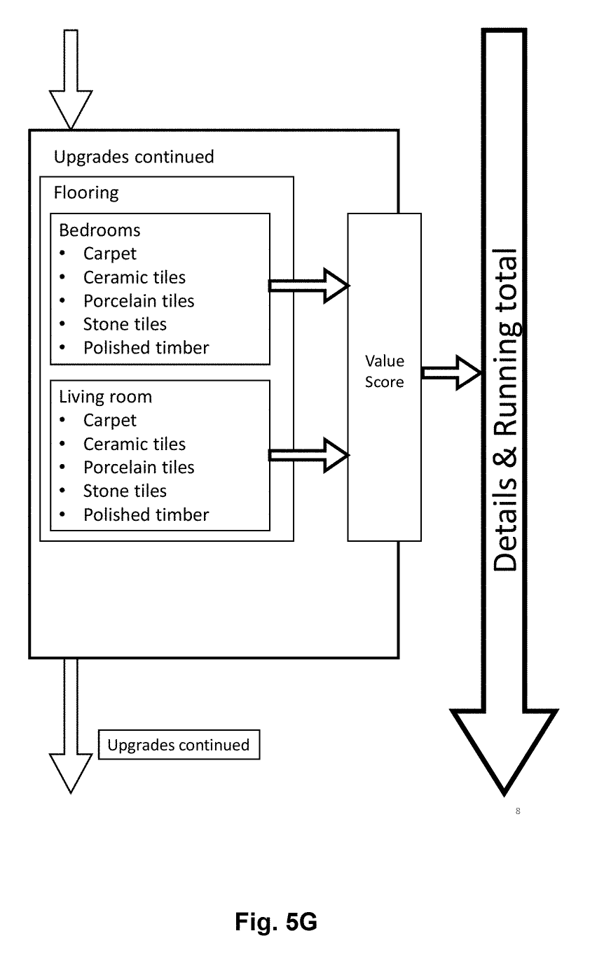

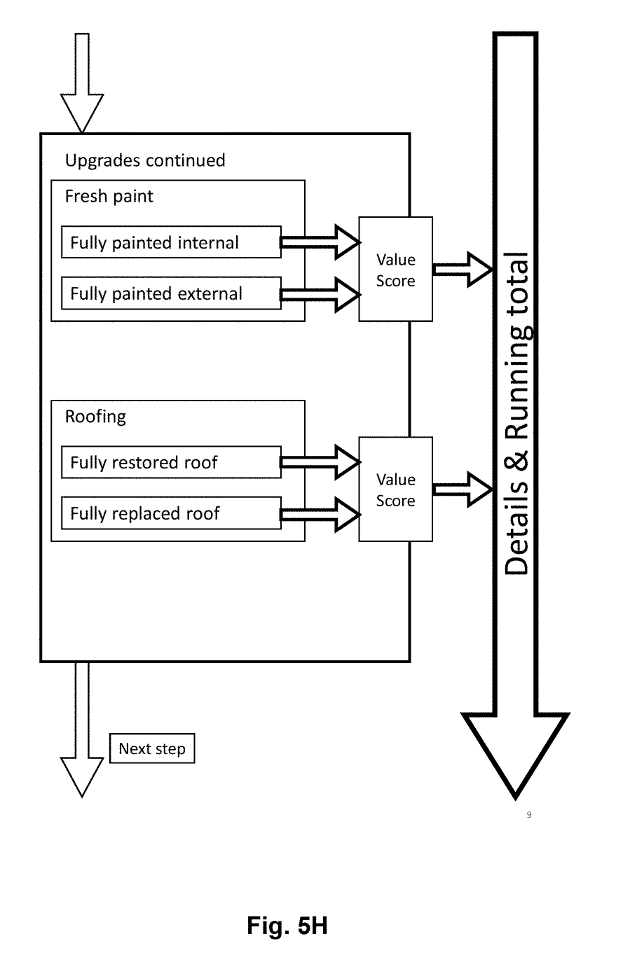

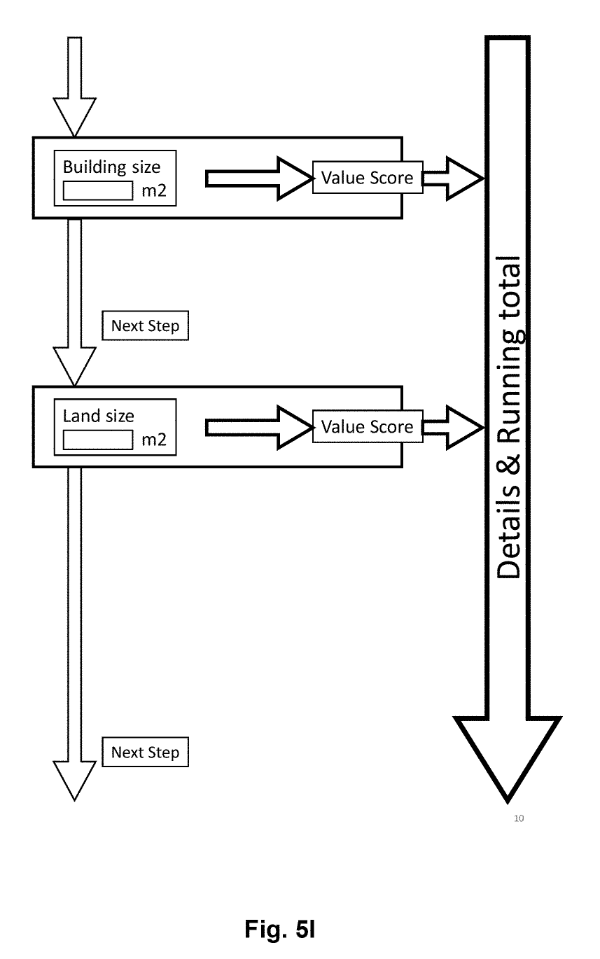

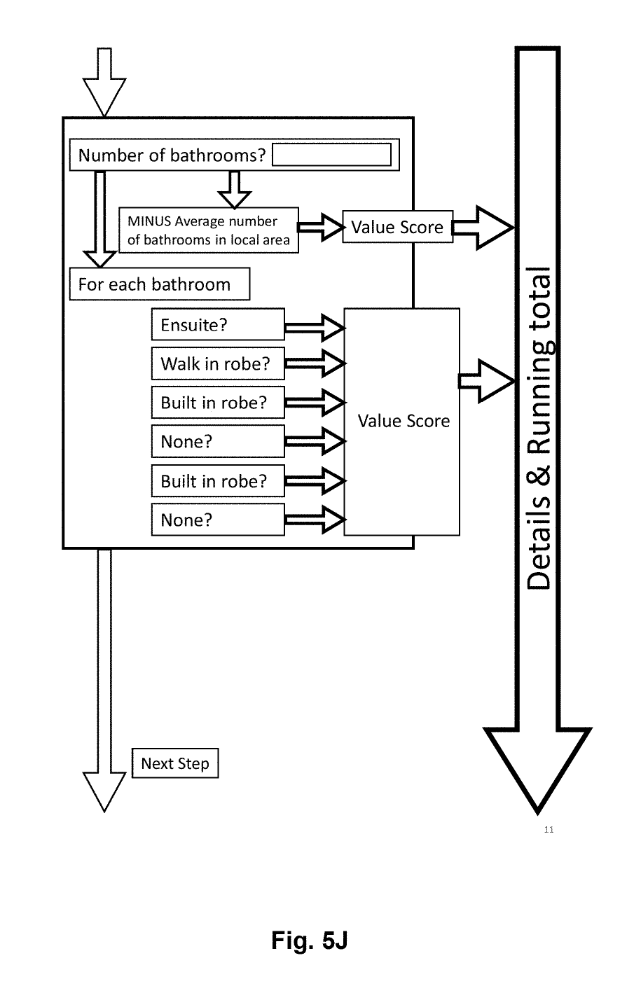

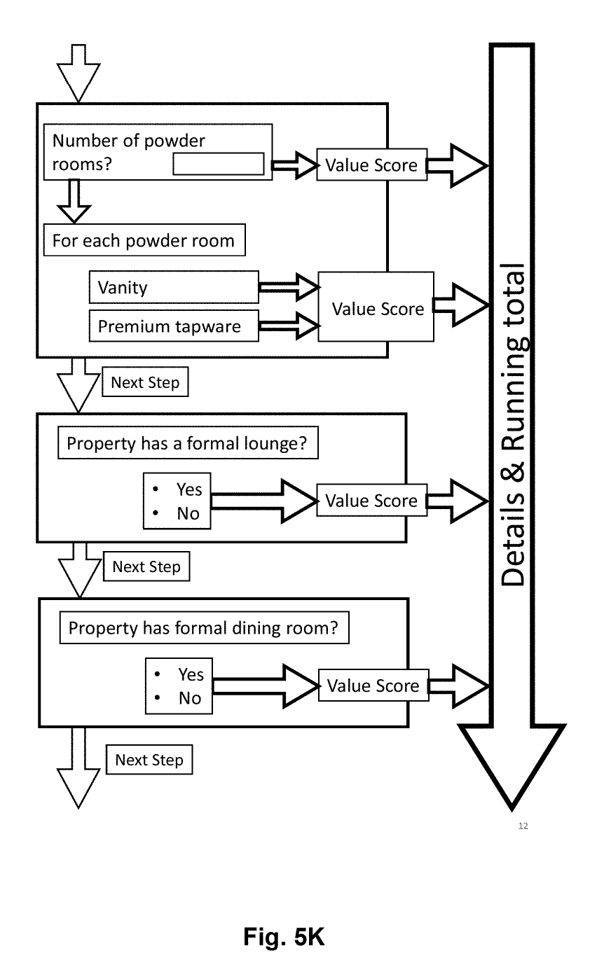

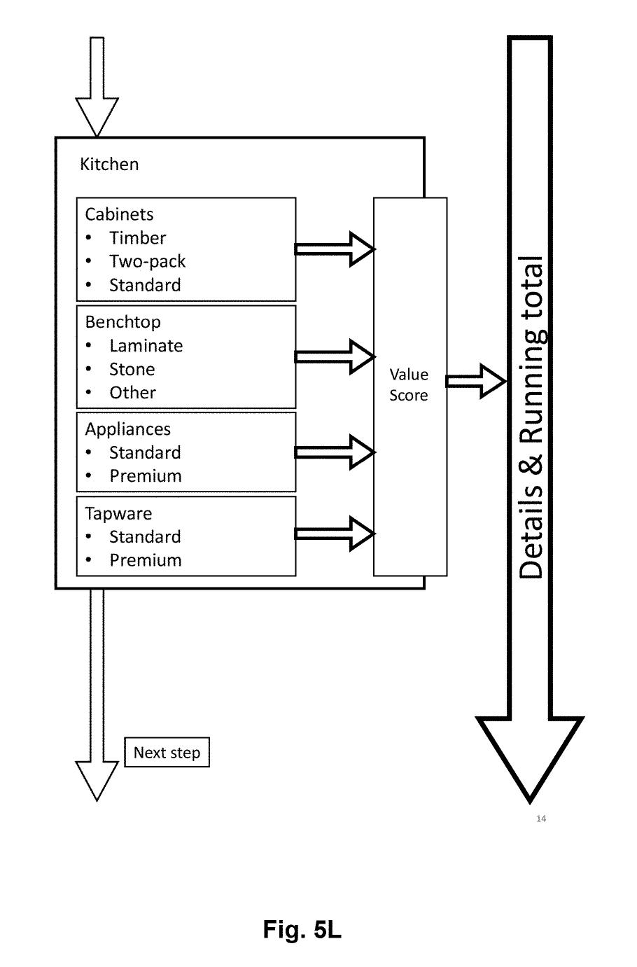

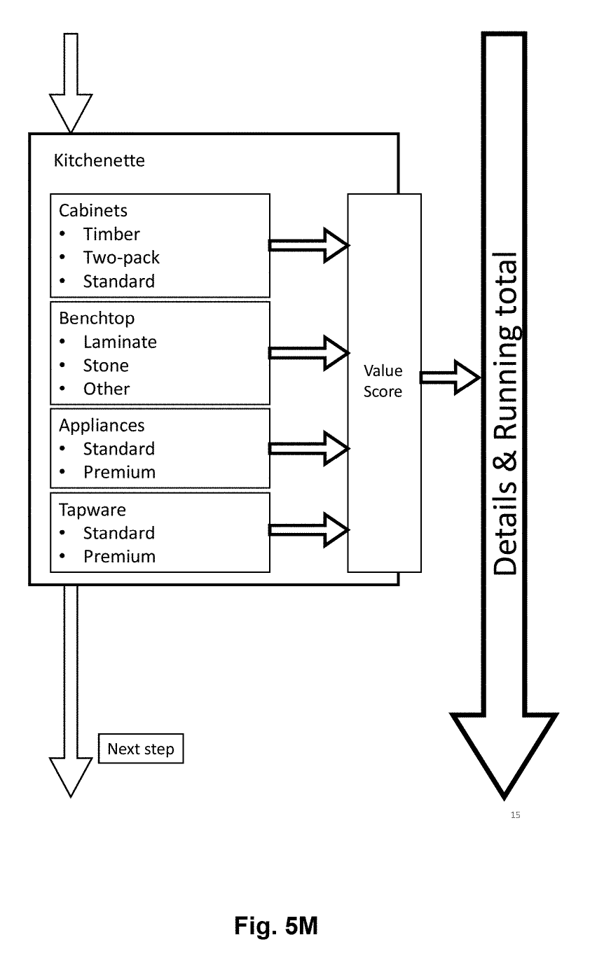

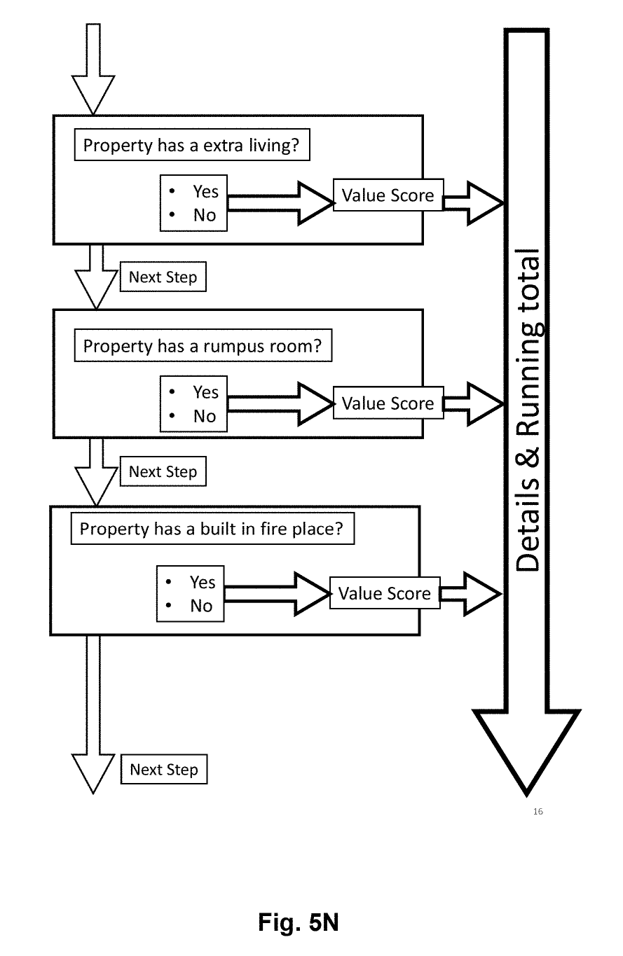

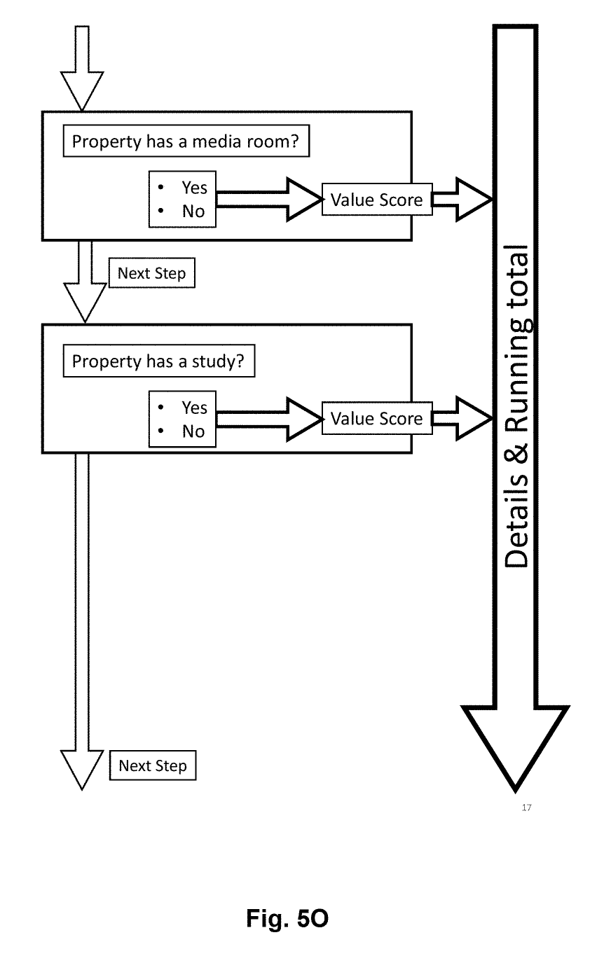

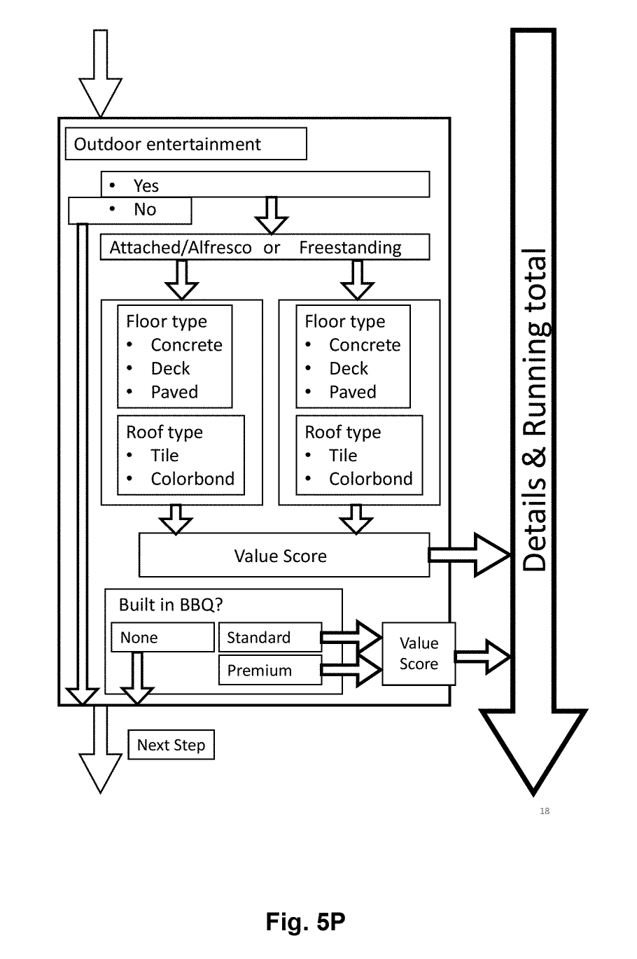

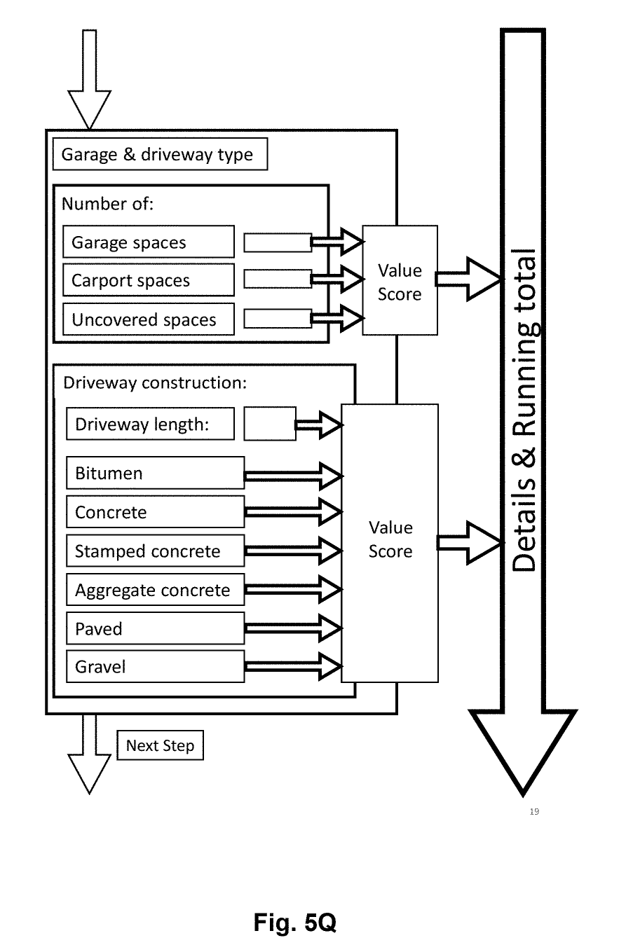

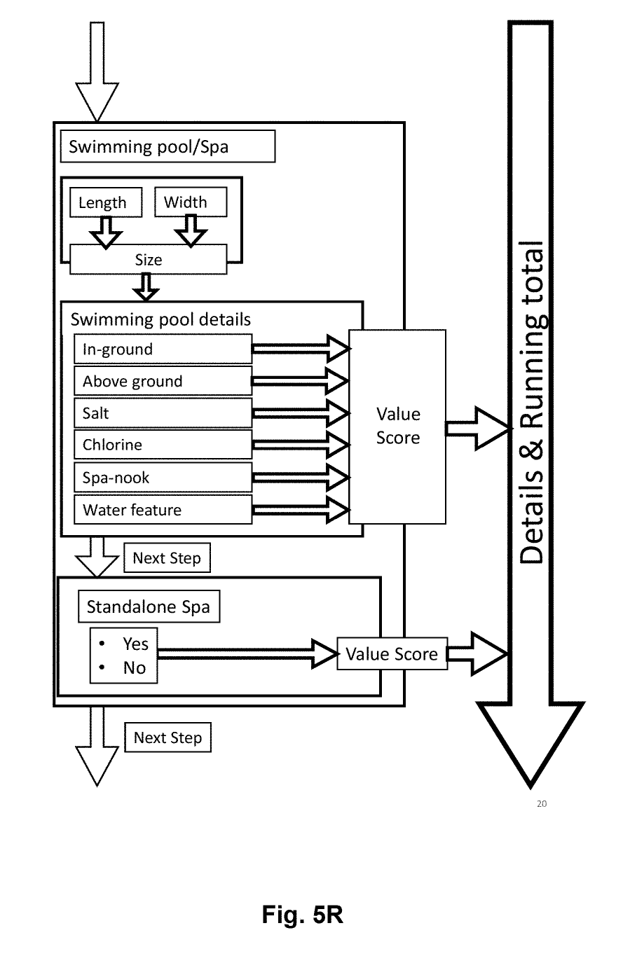

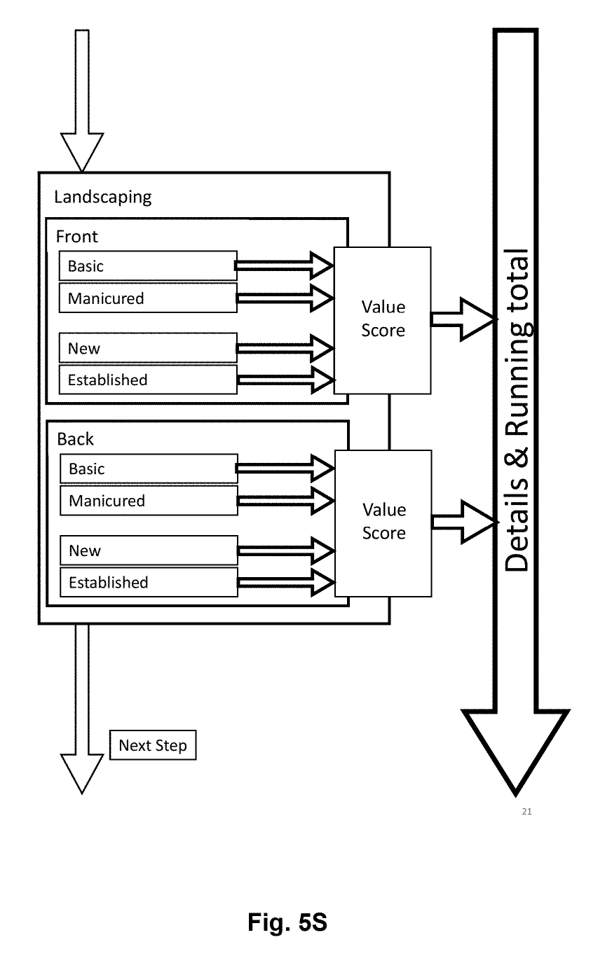

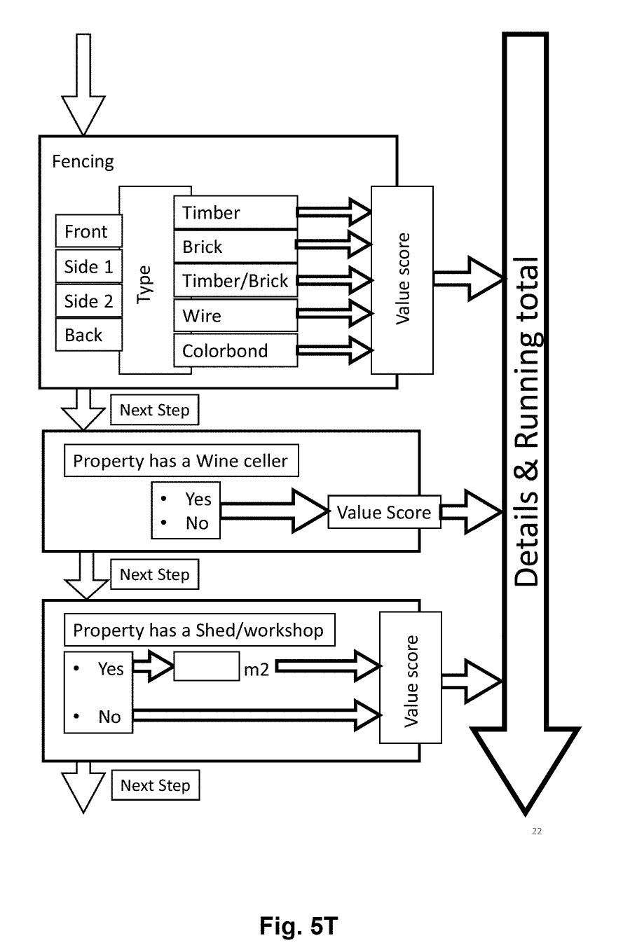

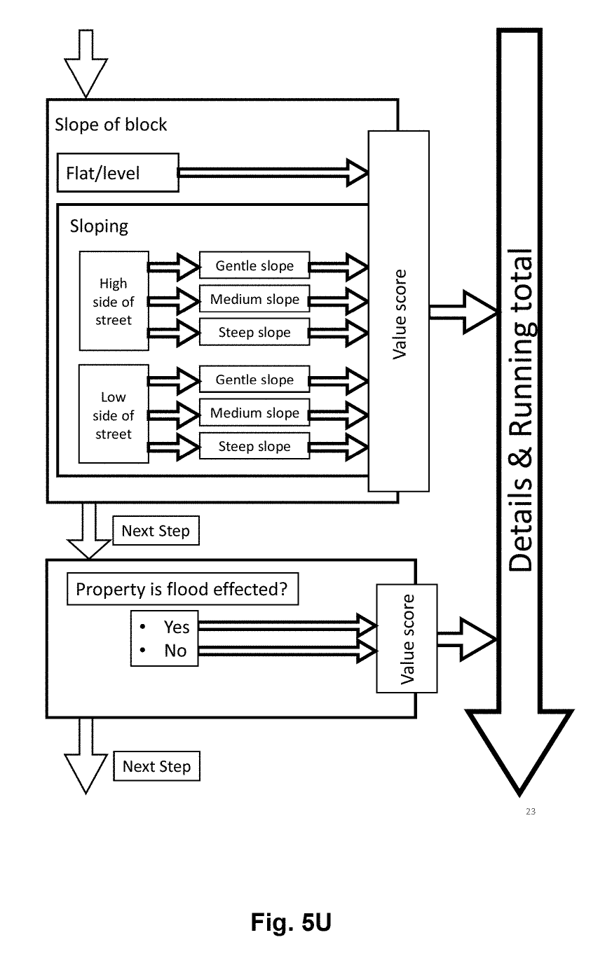

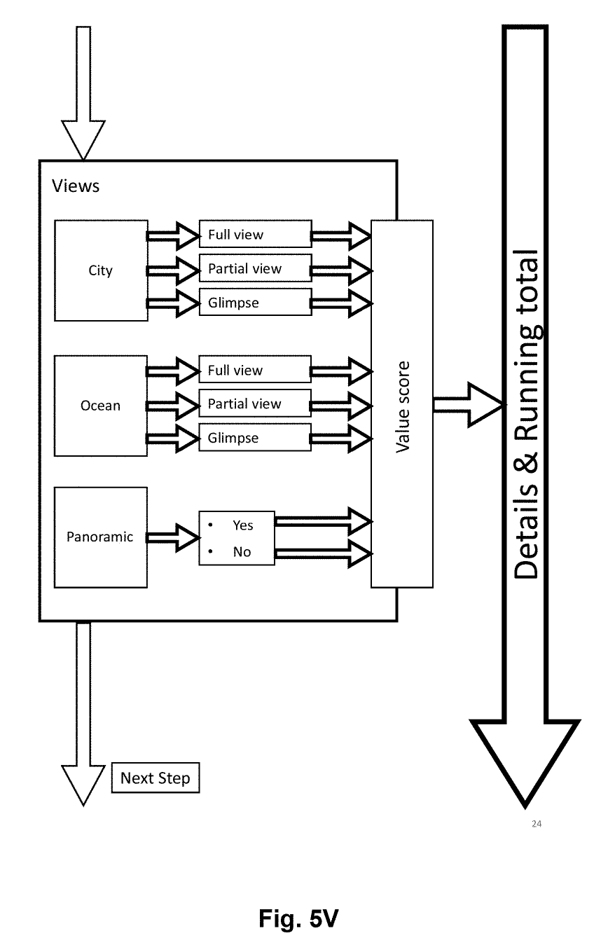

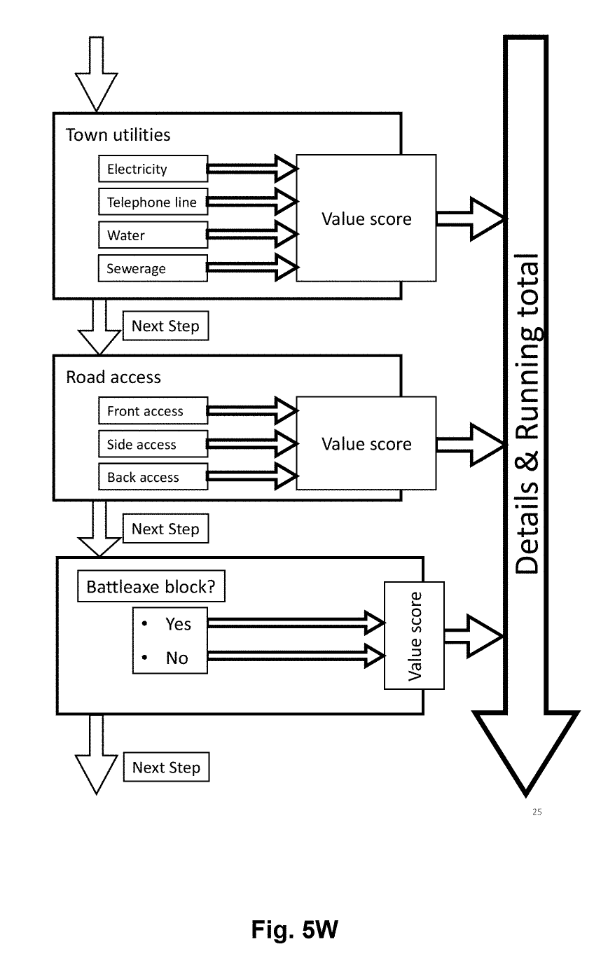

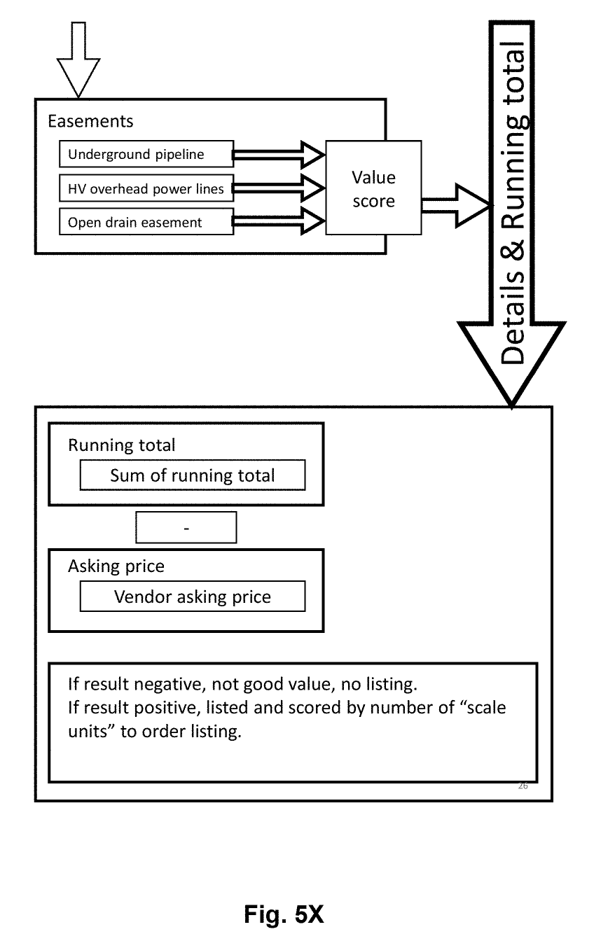

FIGS. 5A to 5Z are schematic representations illustrating a prospective seller populating an attribute template for a product to be offered for sale. Continuing the example from FIG. 2, the prospective seller is selling a house and has selected “real estate” from a set of product types that are offered by the online marketplace 224. FIG. 5A begins with a “Start listing” box and the seller then completes a first attribute “Type of property” by selecting which type of real estate is to be offered for sale, from the group that includes: house, villa, townhouse, apartment, residential land, acreage, or rural. The ratings calculator 222 calculates an attribute rating value for the attribute “Type of property”. In one implementation, the template displays a core set of attributes, such as the property type, number of bedrooms, and postcode, for example, but does not display the attribute rating values to the user. Rather, the user is presented with an overall rating value at the end of the process. In another implementation, the template displays a running total of the sum of attribute rating values and displays the running total on a side portion of the display. The running total is optionally displayed with other information relating to the property for sale.

In FIG. 5B, the seller enters details relating to “Address of listing” attribute for the property for sale, including, for example, the unit/apartment number, street number, street name, suburb state, and postcode/zipcode. The ratings calculator 222 uses this information in conjunction with statistics derived from the statistics database 280 to determine the size of value score units and averages.

The seller also completes a “Zone of property” attribute, by selecting one of city zoning, residential, commercial, industrial, or agricultural and the ratings calculator 222 determines an attribute rating value for the “Zone of property” attribute.

FIG. 5C relates to the attributes “Age of building” and “Number of bedrooms”. The seller enters the age of the building in years and the ratings calculator 222 determines an attribute rating value for the “Age of building” attribute. The seller then enters the number of bedrooms. In this implementation, the ratings calculator subtracts the average number of bedrooms for related properties in the local area from the number of bedrooms entered by the seller to determine an attribute rating value. For each bedroom, the seller also provides ancillary information indicating whether the bedroom has an ensuite, walk in wardrobe, built in wardrobe, or none of the above to generate a further attribute rating value.

FIG. 5D relates to a “Construction type” attribute. The seller selects a relevant construction type from full brick, weatherboard, concrete panel or Hebel. The seller then selects a frame type of either timber or steel and indicates whether or not asbestos was used in construction of the property. The ratings calculator 222 determines an attribute rating value for each of these attributes.

FIG. 5E relates to upgrades to the property. The seller provides information relating to kitchen upgrades, including the type of cabinets, benchtop type, appliances, and floor to generate an “Upgrades” attribute rating value. FIG. 5F continues the upgrades information, with the seller providing information relating to bathroom upgrades and FIG. 5G relates to flooring upgrades throughout the property, based on the type of flooring material used in the bedrooms and living room. Further, FIG. 5H relates to painting and roofing upgrades to the property.

In FIG. 5I, the template requests information from the seller relating to the floor area of the building and the overall land size of the property. FIG. 53 relates to the number of bathrooms, with the ratings calculator 222 subtracting the average number of bathrooms for properties in the local area from the number of bathrooms in the property for sale in order to determine an attribute rating value in relation to the number of bathrooms. The seller also provides information relating to whether each bathroom is an ensuite, has a walk in wardrobe, a built in wardrobe, or none of these.

FIG. 5K relates to the number of powder rooms, if any, and for each powder room determines an attribute rating value based on the presence of a vanity and premium tapware. Further, the seller provides information relating to whether or not the property has a formal lounge and/or a formal dining room.

FIG. 5L relates to the standard of the kitchen, wherein the seller provides information relating to the type of cabinets, type of benchtop, grade of appliances, and grade of tapware. Similarly, FIG. 5M, relates to the standard of any kitchenette, wherein the seller provides information relating to the type of cabinets, type of benchtop, grade of appliances, and grade of tapware.

FIG. 5N relates to whether the property has an extra living room, a rumpus room, or a built in fireplace and FIG. 5O relates to whether the property has a media room or study. FIG. 5P relates to the outdoor entertainment facilities of the property. If the property has outdoor entertainment facilities, then an attribute rating value is determined based on whether the facilities are attached or freestanding, the floor type, and roof type. The seller also provides information as to whether the property has a built in BBQ and, if so, whether the BBQ is of standard or premium grade.

FIG. 5Q relates to garage and driveway facilities, based on the number of garage spaces, carport spaces, and uncovered spaces. The seller also provides information relating to the driveway construction, such as length, and material. FIG. 5R relates to swimming and spa facilities, based on length, width, and other features.

FIG. 5S relates to landscaping features of the property, such as the level of manicuring of the front and back gardens and whether each garden is new or established. FIG. 5T relates to fencing attributes, the presence of a wine cellar, and any shed or workshop. FIG. 5U relates to the slope of the block and whether the property is flood affected.

FIG. 5V relates to the general outlook of the property. In particular, the seller indicates whether the property has full, partial, or glimpse views of the city, ocean, or a local panorama/vista. FIG. 5W relates to town utilities, road access, and whether or not the property is a battleaxe block.

FIG. 5X relates to any easements, such as pipes, powerlines, and drains, that might impact the property. FIG. 5X also provides a sum of the individual attribute rating values and by comparing the sum to the vendor asking price determines an overall rating value.

Table 1 shows an example of statistical data associated with property sales in a selected postcode. In this example, the average sales price is $450,000, relating to a 3 bedroom house on a block of land 600 m² in size.

TABLE 1

| | | | | Weighted |
|---|---|---|---|---|
| Description | Unit | Average | Weightings | Scores |
| Price | $ | 450,000 | — | |
| Land Size | m² | 600 | 1 | 600 |
| Building Size | m² | 200 | 1 | 200 |
| Bedrooms | # | 3 | 9 | 27 |
| Bathrooms | # | 2 | 8 | 16 |
| Garage | # | 1 | 6 | 6 |
| Swimming Pool | Y/N (1/0) | 0 | 10 | 0 |
| View | Y/N (1/0) | 0 | 10 | 0 |
| Water Frontage | Y/N (1/0) | 0 | 10 | 0 |

| | |
|---|---|
| Sum of the weighted scores (attribute rating values) | 849 |

In the example of Table 1, the set of attributes appear in the left-most column, below the statistical average price for the selected postcode. That is, the set of attributes include: land size, building size, bedrooms, bathrooms, garage, swimming pool, view, and water frontage. A value score unit size is determined for the property type, being a house. The value score unit size in this arrangement is determined by dividing the average sale price by the sum of the weighted scores. In this case, the sum of the weighted scores is 849, so the value score unit size is:

Average sale price/sum of weighted scores=450,000/849=530.035 Eqn (1)

The weighted scores are the product of the average values and the respective weightings. The weightings are based on the type of property and the relative value of the attribute to properties in the selected postcode. In this example, a swimming pool has a weighting of 10, indicating that the presence of a swimming pool has a greater impact on the value of a property than the presence of a garage, which has a weighting of 6. The actual weightings used depend on the property and location.

Table 2 shows the calculations used to determine an overall value rating for a property to be listed for sale in the same postcode to which the statistical data in Table 1 relate. In this example, the user has provided a sale price of $550,000 for a property on 800 m², with a building size of 200 m² and 6 bedrooms.

TABLE 2

| | | User Entered | | Weighted |
|---|---|---|---|---|
| Description | Unit | Value | Weightings | Scores |
| Price | $ | 550,000 | — | |
| Land Size | m² | 800 | 1 | 800 |
| Building Size | m² | 200 | 1 | 200 |
| Bedrooms | # | 6 | 9 | 54 |
| Bathrooms | # | 2 | 8 | 16 |
| Garage | # | 1 | 6 | 6 |
| Swimming Pool | Y/N (1/0) | 0 | 10 | 0 |
| View | Y/N (1/0) | 0 | 10 | 0 |
| Water Frontage | Y/N (1/0) | 0 | 10 | 0 |

| | |
|---|---|
| Sum of the weighted scores (attribute rating values) | 1076 |

The sum of the weighted scores (attribute rating values) multiplied by the value score unit produces:

1076×530.035=570,318 Eqn (2)

Subtracting this value from the vendor's asking price provides:

570,318−550,000=20,318.02 Eqn (3)

Dividing the difference by the value score unit size provides an overall rating score:

20,318.02/530.035=38.33. Eqn (4)

As the overall rating score is positive, this indicates that the property represents good value for money for the price being asked.

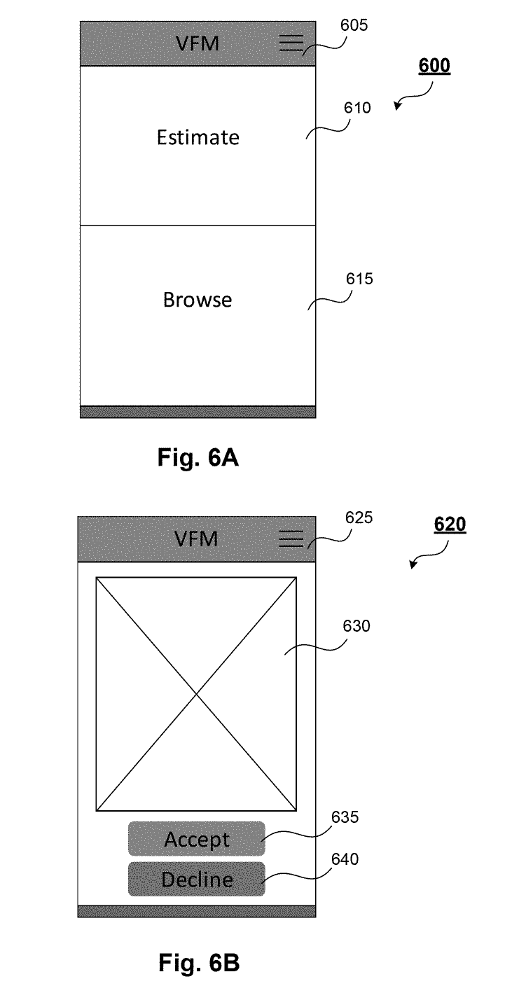

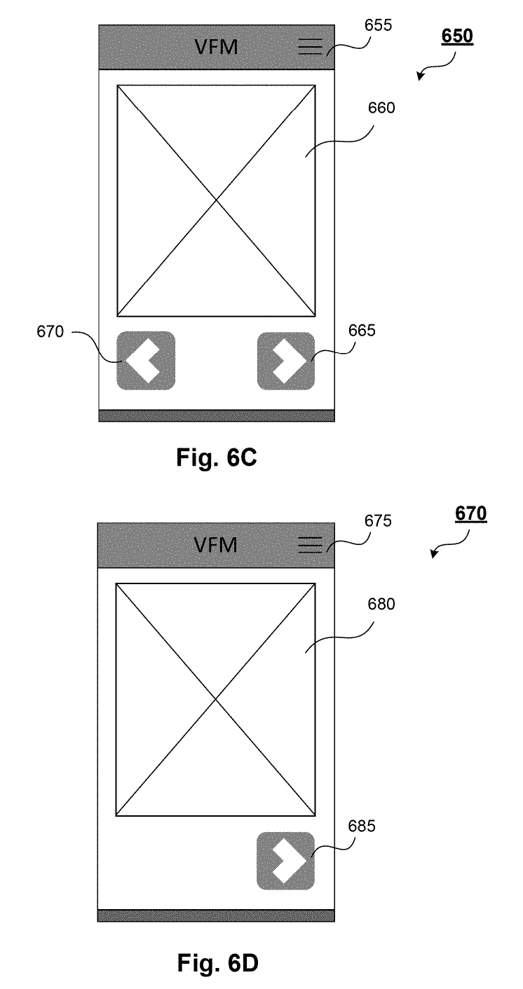

The present disclosure also provides an alternative embodiment in which a software application (“app”) executes on a computing device to provide a user with a value estimation for a product that is offered for sale, based on a set of input parameters and a set of statistics. FIGS. 6A to 6D are schematic representations of screenshots of a computing device executing a software application embodying a method for generating a value estimation for a product offered for sale.

In one arrangement, the computing device is the first computing device 210 of FIG. 2, wherein a user uses the computing device 210 to access the app. The computing device 210 may be implemented using any computing device, including, for example, but not limited to, a personal computer, a laptop, a smart phone, a tablet computing device, or a phablet computing device. In one example, the app is configured to provide a value for a house that is up for sale or auction.

FIG. 6A shows an opening screenshot 600 having a Value For Money (VFM) menu bar 605 allowing a user to navigate through the app. The opening screenshot 600 also shows: (i) an estimate screen portion 610 for displaying a value estimate; and (ii) a browsing portion 602 for enabling the user to navigate through the app.

FIG. 6B shows a screenshot 620 having a VFM menu bar 625 and a disclaimer portion 630 that displays to the user various information relating to any disclaimers that an administrator of the app wants to provide. Such disclaimers may include information regarding the accuracy of any value estimation that is to be provided, the nature and age of any statistical data that is being used, and any further warranties and/or legal notices that might be relevant. A user is able to accept the conditions stipulated in the disclaimers by activating an Accept button 635. Alternatively, the user does not accept the conditions and activates a Decline button 640, which returns the user to the opening screenshot 600 or closes the app.

FIG. 6C shows a screenshot 650 having a VFM menu bar 655, a display portion 660 for displaying information to the user, a Back button 670, and a Forward button 665. The app displays information to the user in the display region 660 and also receives input from the user in the display region 660. Such a configuration enables the app to implement a “wizard” type arrangement that leads a user through a predefined sequence of steps to obtain relevant input data relating to a product to be purchased. Depending on the particular implementation, the input may be in the form of free text, check boxes, drop down boxes, range sliders, forms, templates, and the like, or any combination thereof.

In one implementation, the app is adapted to provide a user with a price estimate (i.e., valuation) in relation to a property. In such an implementation, the app provides a set of different input screens to obtain information about the property, such as, for example, the address, the type of property, the existence of any buildings, construction type, number of bedrooms, number of bathrooms, number of car parking places, internal details of the property, external details of the property, and any other amenities and inclusions.

Once the app receives all of the input data from the user, the app then determines an output estimation, based on the input data and stored statistical data. In one arrangement, the app transmits the received input data from the computing device 210 via the communications network 205 to the server 220. As described above in relation to the method for determining a value rating of a product for sale, the server 220 uses the ratings calculator 222 to process the input data received from the user, in conjunction with statistics relating to the particular property that is in question, derived from the statistics database 280, to generate the output estimation to the user. FIG. 6D shows a screenshot 670 having a VFM menu 675, an output region 680, and a Forward button 685. The Forward button 685 returns the user to a home screen or other predefined portion of the app.

In an alternative implementation, a user accesses the computing device 210 to access a web browser to browse content from the server 222. In such an implementation, the server 222 displays the content to the regions 610, 615, 630, 660, 680.

In one example, a user downloads the app from the server 222 to the computing device 210 for use in relation to a home property purchase. The user attends an auction in relation to a particular property and enters all available information pertaining to the property into the app. Thus, the user enters the street address, that in this instance the property is a house of brick construction, and provides other external and internal attributes of the property. The app transmits the entered data to the server 222, which retrieves statistical data from the statistics database 280 relating to the particular property. Such statistical data may include information for recent sales in the area, crime rates, public transport availability, mortgage details for the area, and the like. The ratings calculator uses the entered data in conjunction with the statistical data to generate a value estimate for the particular property.

Table 3 shows the calculations used to determine a value estimation for a property that is listed for sale in the same postcode to which the statistical data in Table 1 relate. In this example, the user has provided data relating to a property on 800 m², with a building size of 200 m² and 6 bedrooms.

TABLE 3

| | | User Entered | | Weighted |
|---|---|---|---|---|
| Description | Unit | Value | Weightings | Scores |
| Land Size | m² | 800 | 1 | 800 |
| Building Size | m² | 200 | 1 | 200 |
| Bedrooms | # | 6 | 9 | 54 |
| Bathrooms | # | 2 | 8 | 16 |
| Garage | # | 1 | 6 | 6 |
| Swimming Pool | Y/N (1/0) | 0 | 10 | 0 |
| View | Y/N (1/0) | 0 | 10 | 0 |
| Water Frontage | Y/N (1/0) | 0 | 10 | 0 |

| | |
|---|---|
| Sum of the weighted scores (attribute rating values) | 1076 |

For each attribute of the property, the system determines a weighting and a weighted score, as described above in relation to Table 2. The sum of the weighted scores (attribute rating values) multiplied by the value score unit derived from Eqn (1) in relation to Table 1 produces:

1076×530.035=570,318 Eqn (5)

Thus, the system produces a value estimation of $570,318, which is transmitted to a display of the computing device 210 accessed by the user.

### INDUSTRIAL APPLICABILITY

The arrangements described are applicable to the retail, marketing, and real estate industries.

The foregoing describes only some embodiments of the present invention, and modifications and/or changes can be made thereto without departing from the scope and spirit of the invention, the embodiments being illustrative and not restrictive.

In the context of this specification, the word “comprising” and its associated grammatical constructions mean “including principally but not necessarily solely” or “having” or “including”, and not “consisting only of”. Variations of the word “comprising”, such as “comprise” and “comprises” have correspondingly varied meanings.

As used throughout this specification, unless otherwise specified, the use of ordinal adjectives “first”, “second”, “third”, “fourth”, etc., to describe common or related objects, indicates that reference is being made to different instances of those common or related objects, and is not intended to imply that the objects so described must be provided or positioned in a given order or sequence, either temporally, spatially, in ranking, or in any other manner.

Although the invention has been described with reference to specific examples, it will be appreciated by those skilled in the art that the invention may be embodied in many other forms.

1. A method for determining an overall value rating in relation to a product that is to be offered for sale or lease, comprising the steps of:
identifying a product type associated with the product;
determining a set of attributes for the identified product type;
determining an attribute value multiplier associated with each attribute in said set of attributes;
determining a weighted score for each of said attributes, based on a statistical value associated with the attribute and the corresponding attribute value multiplier;
calculating a value score unit size for the product, based on statistical data relating to the product and the product type and a sum of said weighted scores;
presenting an attribute template to a user, said attribute template including said set of attributes;
receiving data from said user in relation to each attribute in said set of attributes;
for each attribute in said attribute template, determining an attribute rating value based on said received data and the attribute value multiplier associated with that attribute; and
determining the overall rating value, based on an asking price submitted by a seller of said product and a product of a sum of the attribute rating values and said value score unit size.

2. The method according to claim 1, wherein the overall rating value is based on the difference between the sum of the attribute rating values and the asking price.

3. The method according to claim 1,
wherein the user is one of a prospective purchaser and said seller, and
further wherein the product type is selected from the group consisting of houses, real estate, cars, apartments, commercial property, land, and boats.

4. The method according to claim 3, wherein the product type is a house and the statistical data includes an average house price for a local area in which the house to be offered for sale is located.

5. The method according to claim 4, wherein the set of attributes includes at least one of zoning type, age of building, number of bedrooms, ensuite, walk in wardrobe, built in wardrobe, construction type, flooring, roofing, building size, land size, number of bathrooms, kitchen fittings, outdoor entertainment facilities, driveway, garage, swimming pool, spa, landscaping, and fencing.

6. The method according to claim 1, wherein the product is a house and the statistical data include a set of average data, wherein the value score unit size is based on dividing an average sale price by a sum of products resulting from multiplying the set of average data by the corresponding attribute value multipliers.

7. The method according to claim 6, wherein the set of average data includes an average land size, average building size, average number of bedrooms, and average number of garaged car spaces.

8. The method according to any one of claim 1, wherein the overall value rating is calculated by dividing a difference between the asking price and an average sale price by the value score unit size.

9. A system for determining an overall value rating in relation to a product that is to be offered for sale or lease, said system comprising:
a server, said server including:
a memory for storing data and a computer program;
a processor coupled to said memory for executing said computer program stored
in said memory;
a ratings application forming part of said computer program, said ratings application including instructions for performing the method steps of:
identifying a product type associated with the product;
determining a set of attributes for the identified product type;
determining an attribute value multiplier associated with each attribute in said set of attributes;
determining a weighted score for each of said attributes, based on a statistical value associated with the attribute and the corresponding attribute value multiplier;
calculating a value score unit size for the product, based on statistical data relating to the product and the product type and a sum of said weighted scores;
presenting an attribute template to a user associated with said product that is to be offered for sale or lease, said attribute template including said set of attributes;
receiving data from said user in relation to each attribute in said set of attributes;
for each attribute in said attribute template, determining an attribute rating value based on said received data and the attribute value multiplier associated with that attribute;
determining the overall rating value, based on an asking price submitted by a seller of said product and a product of a sum of the attribute rating values and said value score unit size.

10. The system according to claim 9, further comprising:
a statistics database for providing said statistical data, each of said server and said statistics database being coupled to a communications network.

11. The system according to claim 10, further comprising:
a computing device accessible by the seller, said computing device being coupled to said communications device and including:
a display device for displaying said attribute template, and
at least one input device for receiving said data from said seller and transmitting said data to said server.

12. The system according to any one of claim 9, wherein said user is a prospective purchaser or said seller.

13. A computer readable storage medium having recorded thereon a computer program for determining an overall value rating in relation to a product that is to be offered for sale or lease, said computer program comprising code for performing the steps of:
identifying a product type associated with the product;
determining a set of attributes for the identified product type;
determining an attribute value multiplier associated with each attribute in said set of attributes;
determining a weighted score for each of said attributes, based on a statistical value associated with the attribute and the corresponding attribute value multiplier;
calculating a value score unit size for the product, based on statistical data relating to the product and the product type and a sum of said weighted scores;
presenting an attribute template to a user, said attribute template including said set of attributes;
receiving data from said user in relation to each attribute in said set of attributes;
for each attribute in said attribute template, determining an attribute rating value based on said received data and the attribute value multiplier associated with that attribute;
determining the overall rating value, based on an asking price submitted by a seller of said product and a product of a sum of the attribute rating values and said value score unit size.

14. A method for determining a value estimate in relation to a product, comprising the steps of:
identifying a product type associated with the product;
determining a set of attributes for the identified product type;
determining an attribute value multiplier associated with each attribute in said set of attributes;
determining a weighted score for each of said attributes, based on a statistical value associated with the attribute and the corresponding attribute value multiplier;
calculating a value score unit size for the product, based on statistical data relating to the product and the product type and a sum of said weighted scores;
presenting an attribute template to a user, said attribute template including said set of attributes;
receiving data from said user in relation to at least one attribute in said set of attributes;
for each attribute in said attribute template, determining an attribute rating value based on said received data and the attribute value multiplier associated with that attribute; and
determining an overall value estimate, based on a product of said value score unit size and a sum of the attribute rating values.

15. The method according to claim 14, wherein the product type is selected from the group consisting of houses, real estate, cars, apartments, commercial property, land, and boats.

16. The method according to claim 15, wherein the product type is a house and the statistical data includes an average house price for a local area in which a house offered for sale is located.

17. A system for determining a value estimate in relation to a product, said system comprising:
a server, said server including:
a memory for storing data and a computer program;
a processor coupled to said memory for executing said computer program stored
in said memory;
a ratings application forming part of said computer program, said ratings application including instructions that when executed on said processor perform the method steps of:
identifying a product type associated with the product;
determining a set of attributes for the identified product type;
determining an attribute value multiplier associated with each attribute in said set of attributes;
determining a weighted score for each of said attributes, based on a statistical value associated with the attribute and the corresponding attribute value multiplier;
calculating a value score unit size for the product, based on statistical data relating to the product and the product type and a sum of said weighted scores;
presenting an attribute template to a user, said attribute template including said set of attributes;
receiving data from said user relating to each attribute in said set of attributes;
for each attribute in said attribute template, determining an attribute rating value based on said received data and the attribute value multiplier associated with that attribute;
determining an overall value estimate, based on a product of said value score unit and a sum of the attribute rating values.
